(19) United States
(12) Patent Application Publication
(10) Pub. No.: US 2009/0086465 A1
(43) Pub. Date: Apr. 2, 2009

(54) Wind-powered generator and blade therefor

(76) Inventors: Andre St-Germain, St-Bonaventure (CA); Raymond Sigouin, Val-David (CA)

Correspondence Address: Franz BONSANG, c/o EQUINOX PROTECTION, 410 - 1500, Du College, St-Laurent, QC, H4L 5G6, CA

(21) Appl. No.: 12/232,474

(22) Filed: Sep. 18, 2008

Related U.S. Application Data
(60) Provisional application No. 60/960,425, filed on Sep. 28, 2007.

(51) Int. Cl. F21V 33/00

(52) U.S. Cl. 362/89

(57) ABSTRACT

A wind-powered generator includes a vertical rotor provided with generally vertically orientated blades having a swept-forward wing shape, a top lighting member and rotor lighting member disposed along the rotor, the blades being made from light-transmitting material.

### FIELD OF THE INVENTION

The present invention is related to the field of wind power generators, and is more particularly directed to such generators that are mountable on top of telecommunication towers or surrounding telecommunication equipment for supplying electrical power thereto.

### BACKGROUND OF THE INVENTION

Wireless telecommunication installations, such as towers, are proliferating due to market needs. To facilitate this proliferation, and to take additional advantage thereof, the present invention brings an innovative solution to the cost-effective operation of telecommunication towers by enabling the use and installation of renewable energy systems on telecommunication relay towers. More specifically, the present invention permits harnessing of wind energy employing wind-powered generators mounted on the telecommunication towers.

The present invention provides energy self-sufficient telecommunication towers. Energy production installations composed of wind-powered generators and storage batteries provide an independent source of energy for telecommunication equipment and even for lighting means for security and advertising signs. Moreover, the present invention facilitates provision, at affordable cost, of basic telecom facilities in remote or isolated areas not served by electricity utilities. However, provision of such wind power generation facilities, using vertical axis wind turbines (VAWT), on telecommunication towers may be difficult using conventional blades for VAWTs.

There is a considerable body of art relating to VAWTs in terms of structure and the blade or vane profiles and their orientation. For example, U.S. Pat. No. 7,083,382 to Ursua describes a rotor with its axis vertically oriented and having radially extending therefrom one or more arms each carrying at least one blade movable to effect a modulation of the drag, the object being to reduce drag and to increase torque. However, the linkages involved in the mounting of the arms and the blades are complex and accordingly costly.

Another example of VAWT is to be found in U.S. Pat. No. 6,942,454 to Ohlmann who proposes a dual rotor system mounted on a support structure rotatable about a third axis on a mounting platform, each rotor system being provided with a plurality of rotor blades. The whole assembly comprising the turbine is again complex in nature and therefore expensive to produce and to maintain.

US patent application publication No.: 2008/0095631 to Bertony discloses a VAWT having a twisted blade or auxiliary blade suitably arrayed to provide in use for the generation of a venturi inducing gap to extend the zone of influence of the turbine beyond the maximum radial extent of the blades. The relative disposition of the main blades and their associated auxiliary blades is crucial to the achievement of the desired objective and requires great attention to detail.

Accordingly, there is a need for a simpler improved blade with a profile for a VAWT.

### SUMMARY OF THE INVENTION

It is therefore a general object of the present invention to provide a simpler improved blade with profile for a VAWT.

It is a further object of the present invention to provide a wind-powered generator mountable on a telecommunications tower or adjacent telecommunications equipment.

Advantageously, the present invention provides to telecommunication towers independent electrical power for the operation of transmission and telecommunication equipment thereon.

Another advantage of the present invention is that it is capable of providing electrical lighting to the top of telecommunications towers for visual identification and localisation at night.

A further advantage of the present invention allows for electricity to be generated without requiring additional supporting infrastructure, thus ensuring a more efficient use of available land for other uses and additionally reducing visual pollution.

Still another advantage of the present invention is that the wind-powered generator, in some embodiments, includes optionally transparent wing-shaped blade or foil surface areas which can carry promotional advertising media such as rotating billboards.

Yet another advantage of the present invention is that it provides a wind-powered generator that does not interfere with telecommunication equipment.

Yet a further advantage of the present invention is that it provides wind blades with a swept-forward wing shape, on at least a portion thereof, to increase the aerodynamic stability and characteristics, for improved overall performance of the wind-powered generator.

According to an aspect of the present invention there is provided a wind-powered generator comprising:
a vertical rotor provided with generally vertically-orientated blades;
a top lighting member; and
rotor lighting members extending along at least part of the vertical rotor;
wherein the blades comprise transparent or translucent skin materials adapted in use for the transmission of light from said rotor lighting members.

According to another aspect of the present invention there is provided a wind-powered generator comprising:
a vertical rotor provided with generally vertically-orientated blades; and
each blade having at least a central portion having a swept-forward wing shape.

In another aspect, the present invention provides a telecommunications tower comprising a vertical structure having a base adapted for anchorage to the ground and a plurality of radiation transmission/reception equipments for telecommunications, the tower being provided with a standalone wind-powered generator having a rotor with generally vertically orientated blades, lighting member located atop a central mast, the rotor being linked to an electrical generator subsystem intended for providing power to telecommunication equipment on the tower and the lighting member, the wind-powered generator being made of non-conducting material thereby in use avoiding electromagnetic interference with telecommunication equipments.

The top lighting member may be of conventional form for identification, danger or warning purposes, and accordingly may be illuminated on a regular intermittent basis such as a flashing or rotating light.

The rotor lighting member may be in flexible strip form wound helically around the rotor to provide light along its length.

The blades are conveniently of aerofoil contour for aerodynamic efficiency and are produced from a transparent or translucent material in order to transmit the light from the rotor lighting member. The material may conveniently in use carry advertising which is illuminated by said rotor lighting member or integral lighting member within the blades.

Other objects and advantages of the present invention will become apparent from a careful reading of the detailed description provided herein, with appropriate reference to the accompanying drawings.

### BRIEF DESCRIPTION OF THE DRAWINGS

Other objects and advantages of the present invention will become apparent from a careful reading of the detailed description provided herein, with appropriate reference to the accompanying drawings, in which similar references used in different Figures denote similar components, and wherein:

FIG. 1 is a perspective view of a wind-powered generator in accordance with an embodiment of the present invention mounted on the top of a telecommunication tower; and

FIG. 2 is an enlarged perspective view of the embodiment of FIG. 1.

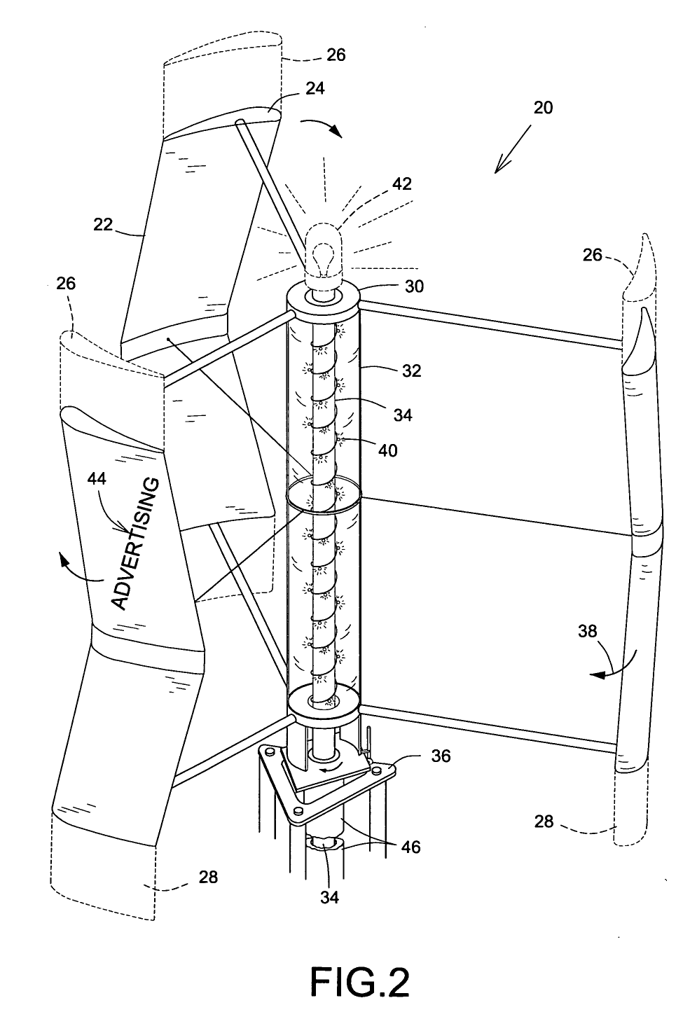

### DETAILED DESCRIPTION OF THE PREFERRED EMBODIMENTS

With reference to the annexed drawings, the preferred embodiment of the present invention will be herein described for indicative purpose and by no means as of limitation.

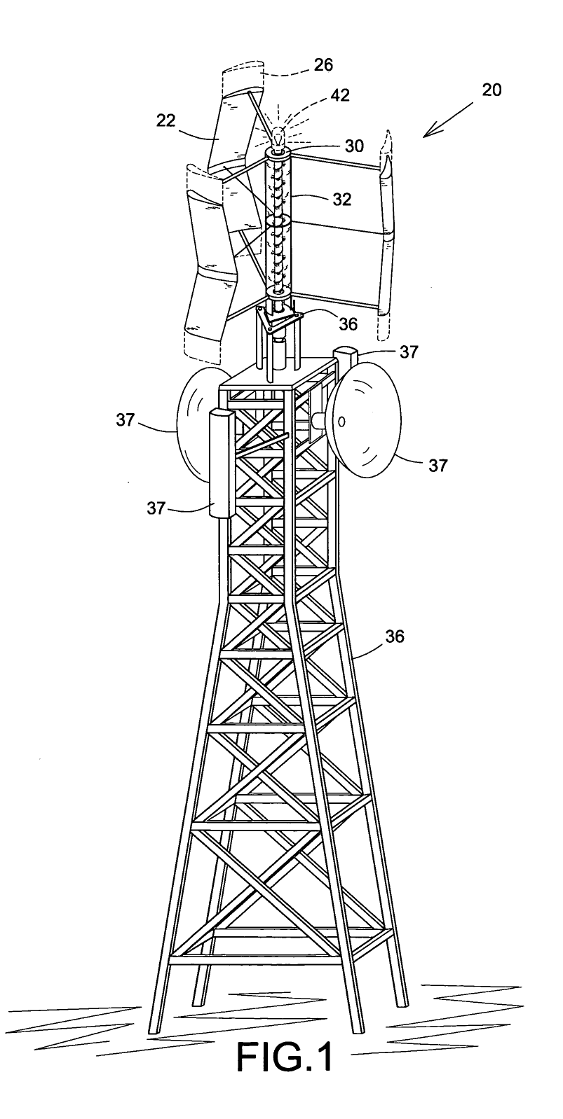

Referring to the drawings, a wind-powered generator, shown generally as 20, is mounted on a generally vertical tower structure 36 or the like typically having a base adapted for anchorage to the ground and a plurality of radiation transmission/reception equipments 37 for telecommunications. The generator 20 is composed of at least one wing-shaped blade assembly 22 mounted on a supporting structure 30. The supporting structure 30 includes a main mast 32 and a rotor shaft 34 which is driven by the wing-shaped blades 22 and the supporting structure 30 assemblies, which rotates due to the force of the wind, shown by arrow 38. The blade assembly 22, or at least a central portion thereof, possesses a shape which is a swept-forward wing 24. Optional top 26 and bottom 28 straight blade extensions, or end portions of the blade assembly 22, can be installed for enhancing the performance of the wind-powered generator 20. Also depicted in FIG. 1 are top lighting member 42 linked by an electrical wire 40 to the electrical generator 46. The electrical wire 40 also provides lighting means or members along the rotor shaft 34. Top lighting member 42 act as visual identification and localisation signs at night for security purpose, such as a flashing or a rotating red light. FIG. 1 also shows advertising signs 44 printed on the external skin of wing-shaped blades 22. Although not specifically illustrated, some rotor lighting means or members could be carried by the blades 22 and powered by the electrical generator 46. Optionally, the blade skin could be made of transparent or translucent materials. The wing-shaped blades can integrate internal lighting members that could provide illumination for advertising signs 44 which could be easily seen from large distance, serving as rotating billboards for promotional purposes. The wind-powered generator 20, and in particular the blade assemblies 22 and the support structure 30, are preferably made of non-conducting material for avoiding electromagnetic interference with telecommunication equipments 37.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

We claim:

1. A wind-powered generator comprising:
a vertical rotor provided with generally vertically-orientated blades;
a top lighting member; and
rotor lighting members extending along at least part of the vertical rotor;
wherein the blades comprise transparent or translucent skin materials adapted in use for the transmission of light.

2. A wind-powered generator according to claim 1 wherein the top lighting member are of conventional form for identification, danger or warning purposes.

3. A wind-powered generator according to claim 2 wherein the top lighting member is a flashing light of suitable hue.

4. A wind-powered generator according to claim 2 wherein the top lighting member is a rotating light of suitable hue.

5. A wind-powered generator according to claim 1 wherein the rotor lighting members is in flexible strip form wound helically around the rotor to provide light along its length.

6. A wind-powered generator according to claim 1 wherein the blades are or aerofoil contour and are produced from transparent or translucent material.

7. A wind-powered generator according to claim 6 wherein the blade material is adapted to carry advertising.

8. A wind-powered generator according to claim 1 wherein the blades are provided with integral internal lighting.

9. A wind-powered generator comprising:
a vertical rotor provided with generally vertically-orientated blades; and
each blade having at least a central portion having a swept-forward wing shape.

10. A wind-powered generator according to claim 9, further comprising:
a top lighting member; and
rotor lighting members extending along at least part of the vertical rotor;
wherein the blades comprise transparent or translucent skin materials adapted in use for the transmission of light from said rotor lighting members.

11. A telecommunications tower comprising a vertical structure having a base adapted for anchorage to the ground and a plurality of radiation transmission /reception equipments for telecommunications, the tower being provided with a standalone wind-powered generator having a rotor with generally vertically orientated blades, lighting member located atop a central mast, the rotor being linked to an electrical generator subsystem intended for providing power to telecommunication equipment on the tower and the lighting member, the wind-powered generator being made of non-conducting material thereby in use avoiding electromagnetic interference with telecommunication equipments.
